(19) United States
(12) Patent Application Publication
(10) Pub. No.: US 2026/0250538 A1
(43) Pub. Date: Aug. 27, 2026

(54) Resin Particle Dispersion for Inkjet Printing

(71) Applicant: Agfa NV, Mortsel (BE)

(72) Inventors: Hubertus Van Aert, Mortsel (BE); Johan Loccufier, Mortsel (BE); Bingyu Yang, Mortsel (BE); Jens Lenaerts, Mortsel (BE)

(73) Assignee: Agfa NV, Mortsel (BE)

(21) Appl. No.: 18/714,173

(22) PCT Filed: Nov. 21, 2022
(86) PCT No.: PCT/EP2022/082595

§ 371 Date: May 29, 2024

(30) Foreign Application Priority Data
Dec. 2, 2021 (EP) 21211860.8

(51) Int. Cl. C09D 11/54; B41M 5/00; B41M 7/00; C09D 5/02; C09D 11/322; C09D 11/38; C09D 175/04

(52) U.S. Cl. CPC C09D 11/54; B41M 5/0017; B41M 7/009; C09D 5/027; C09D 11/322; C09D 175/04; C09D 11/38

(57) ABSTRACT

Liquids for inkjet printing such as pre-treatment compositions, aqueous inkjet inks and overcoat varnishes comprising a surfactant according to Formula (I), (II) or (III) and a resin particle comprising a crosslinked polymeric shell, the polymeric shell comprises a polymer selected from the group consisting of poly(urea), poly(urethanes), poly(amides), poly(amines), poly(imines), poly(esters), poly(carbonates), poly(sulfonamides) or combinations thereof.

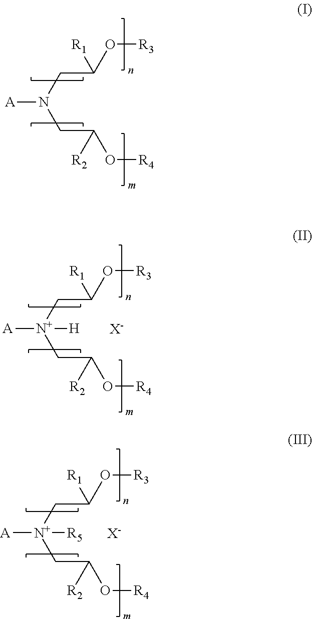

### TECHNICAL FIELD

The invention relates to resin particle dispersions suitable for inkjet printing, more specifically for pre-treatment compositions for inkjet printing on porous and non-porous substrates and for overcoat varnishes to be applied on printed images.

### BACKGROUND ART

Nowadays, there is a growing area of digital pre-printing of liners for corrugated packaging and corrugated card boards. The pre-printing of primers or pre-coats improves the image quality of the image which is printed upon the pre-coat. The possibility to apply a pre-coat, only of the parts which will carry the image, makes it possible to reduce consumption of the pre-coat composition. As the presence of pre-coat negatively influences the adhesion of glue, it is also beneficial to not apply pre-coat on the parts of the packaging material which has to be glued.

Inkjet printing is a growing area of printing of liners for corrugated packaging and of corrugated and folded card boards. In printing of liners for corrugated card boards, usually flexographic printing or offset printing is performed for applying a pre-coat or primer.

In order to obtain high quality images, the pre-coat is a composition capable of receiving ink and holding colorants in the ink to a greater degree than a substrate not treated with a pre-coat. In particular, the pre-coat is capable of holding colorants at or near the surface of a substrate so that optical density and image quality such as ink bleeding and coalescence of the printed image may be improved.

The colorant in aqueous inkjet inks for card board printing can be a dye or a pigment. Pigment based inks have the advantage of providing images with a higher light fastness than dye based inks. To bind the pigments to the substrate preferably reactive binder technology has been introduced into the inks but also into the pre-coats. Several approaches have been disclosed in the patent literature.

WO2014/039306A discloses a pre-treatment for digital printing on substrates comprising an aqueous cationic polyurethane dispersion, coagulating acids, and a reactive crosslinking moiety.

WO 2018/017089 describes a sprayable pre-coat for corrugated linerboard or containerboard packaging as packaging material. The pre-coat composition contains a polyvalent metal salt, a wax, a dispersing agent, a latex and water. The latex includes monomers such as styrene, 1,3-butadiene, acrylonitrile or combinations thereof. The ability to fix colour pigments to the substrate is still moderate leading to an easy rubbing off the image from the substrate.

US2009/0226678 discloses an ink set comprising a fixing liquid for making pigments of inkjet inks fixed, comprising a polymer fine particle synthesized from an alkyl (meth)acrylate and/or cyclic alkyl (meth) acrylate, and a reactant being a block isocyanate, an oxazoline-containing polymer, or a polycarbodiimide.

EP3564318A describes core/shell particles for use in inkjet inks having non-ionic and anionic stabilising groups. Due to the presence of the anionic charges, these particles cannot be combined with fixing agents of a pre-treatment composition due to the cationic charge of the fixing agents. Flocculation and poor colloidal stability is to be expected.

WO2018/138069 discloses a pre-treatment liquid comprising capsules composed of a polymeric shell surrounding a core, the core comprising one or more chemical reactants capable of forming a reaction product upon application of heat and/or radiation and the shell is stabilized by cationic dispersing groups. The chemical reactants are preferably blocked isocyanates.

In inkjet printing on liners for corrugated packaging, folding boards and corrugated card boards, often a varnish overcoat may be applied and dried on top of the printed image and pre-treatment coating matrix. This type of coated layer system may provide increased water or moisture resistance and enhanced durability for inkjet printed images that can survive high temperatures and mechanical forces often present in corrugation packaging applications.

The overcoat varnishes often used in corrugated printing is aqueous based and comprises further resins such as polystyrene polymer, polystyrene copolymers, polyacrylate, polystyrene acrylate copolymers, polyurethane resin, or heat cross-linkable polymers.

These polymers have a tendency for film formation in the nozzles of the print head and in the ink supplies. Hence, if the overcoat varnish is applied by inkjet technology, the above described polymers will lead to reliability problems during printing. In industrial applications, system reliability and especially jetting reliability is of utmost importance. Moreover, the protecting ability of inkjet printed images by the dried resins is still to be improved.

The introduction of chemical reactants in aqueous liquids suitable for inkjet printing with pigment based inks such as pre-treatment liquids and overcoat varnishes, represent shelf-life stability problems due to the reactivity of the chemical reactants, health and safety issues, more particularly for food contact and leads to bad spreading of aqueous inkjet inks onto pre-treatment coatings, leading to a reduced image quality. Furthermore, there is still a need for binder technology which guarantees reliable jetting behaviour of jettable liquids and which is deployable in different liquids for inkjet printing.

### SUMMARY OF INVENTION

It is the objective of the present invention to provide a solution to the above stated problems. The objective has been achieved by providing a pre-treatment composition of resin particles as defined in Claim 1.

It is another embodiment of the invention to provide an over coat varnish for inkjet printing as defined in Claim 6.

It is another embodiment of the invention to provide a fluid set containing an aqueous inkjet ink and a pre-treatment composition of Claim 1 as defined in Claim 7.

It is another embodiment of the invention to provide a printing method using a pre-treatment composition as defined in Claim 9.

Other features, elements, steps, characteristics and advantages of the present invention will become more apparent from the following detailed description of preferred embodiments of the present invention. Specific embodiments of the invention are also defined in the dependent claims.

Preferred embodiments of the invention are also defined in the dependent claims.

### BRIEF DESCRIPTION OF THE FIGURES

FIG. 1.: Pattern used for inkjet printing during the evaluation of the image quality and physical properties of images obtained with pre-treatment compositions. The pattern contains solid areas and negative text with different size ranging from 1 pt to 16 pt.

### DESCRIPTION OF EMBODIMENTS

### A. Aqueous Dispersion of a Resin Particle and a Surfactant

### A.1. Surfactant

The objectives of the present invention are realized by a liquid for inkjet printing such as a pre-treatment liquid, inkjet ink or overcoat varnish comprising an aqueous dispersion comprising a surfactant according to Formula I, II or III and a resin particle comprising a polymeric shell. Preferably, the resin particle further comprises a second polymer.

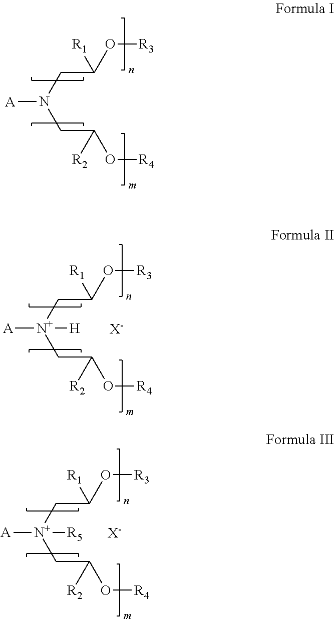

Wherein

$$n + m \geq 2 ,$$

R₁, R₂ is H, CH₃ or CH₂OH,
R₃, R₄ is H, a substituted or unsubstituted alkyl group, a substituted or unsubstituted alkenyl
R₅ is a substituted or unsubstituted alkyl group, a substituted or unsubstituted alkenyl group, a substituted or unsubstituted alkynyl group, a substituted or unsubstituted aralkyl group, a substituted or unsubstituted alkaryl group
A is a substituted or unsubstituted alkyl group, a substituted or unsubstituted acyl group.

The surfactant according to Formula I, II or III is preferably added during the preparation of the resin particles.

Suitable surfactants according to Formula I are alkyl amine ethoxylates such as Ethoxylated stearylamine (e.g. tradename Ethomeen 18/25), Ethoxylated laurylamine (e.g. trade name Pionin D 3120), coco alkyl amine ethoxylate (e.g. tradename Ethomeen C25 or Genamin C 150), Ethoxylated oleylamine (e.g. tradename Ethomeen O 25), Ethoxylated hexadecylamine, Ethoxylated tetradecylamine, Decylamine ethoxylate, α,α′-[(hexylimino)di-2,1-ethanediyl]bis[ω-hydroxy-poly(oxy-1,2-ethanediyl)]. Other suitable surfactants according Formula I are branched alkyl ethoxylate amines such as: α,α′-[(2-propylheptyl)imino]di-2,1-ethanediyl]bis[ω-hydroxy-Poly(oxy-1,2-ethanediyl)].

Suitable surfactants according to Formula II are protonated alkyl amine ethoxylates such as: α,α′-[(dodecylimino)di-2,1-ethanediyl]bis[ω-hydroxy-poly(oxy-1,2-ethanediyl)], hydrochloride.

Suitable surfactants according to Formula III are quaternized derivatives of alkyl amine ethoxylates such as: Stearylmethyldipoly(oxyethylene) ammonium chloride and quaternized alkyl amido ethoxylates such as α,α′-[[methyl-(9Z)-9-octadecenyliminio]di-2,1-ethanediyl]bis[ω-hydroxy-poly(oxy-1,2-ethanediyl)] chloride (e.g. tradename Ethoquad O 25), α,α′-[(dodecylmethyliminio)di-2,1-ethanediyl]bis[ω-hydroxy-poly(oxy-1,2-ethanediyl)] chloride (e.g. tradename Nissan Cation L 207), α,α′-[(dodecylmethyliminio)di-2,1-ethanediyl]bis[ω-hydroxy-poly(oxy-1,2-ethanediyl)methyl sulfate, α,α′-[(dodecylmethyliminio)di-2,1-ethanediyl]bis[ω-hydroxy-poly(oxy-1,2-ethanediyl)] chloride, α,α′-[[octadecyl(phenylmethyl)iminio]di-2,1-ethanediyl]bis[ω-hydroxy-poly(oxy-1,2-ethanediyl)] chloride, α,α′-[(9Z,12Z)-(2,3-dihydroxypropyl)-9,12-octadecadien-1-yliminio]di-2,1-ethanediyl]bis[ω-hydroxy-poly(oxy-1,2-ethanediyl)] chloride (tradename Maquat SL 5), α,α′-[(didodecyliminio)di-2,1-ethanediyl]bis[ω-hydroxy-poly(oxy-1,2-ethanediyl)] chloride.

Without being bound by any theory, it is thought that due to the 2 or more chains of polyethylene glycol in the surfactant according to Formula I, II and III, the surfactant has a more cone shape compared to alkyl ethoxylate surfactants having only one polyethylene glycol chain. The surfactant will be present at the surface of the resin particles of the dispersion. Due to the small particle size, the particles have a large curvature. Therefore, surfactants which have a more cone shape due to the 2 or more polyethylene glycol chains will provide better steric stabilisation of the particle than surfactants with only one polyethylene glycol chain.

Due to the tertiary nitrogen atom, which can be protonated or quaternized, the surfactant according to Formula II and Ill may further give extra electrostatic stabilisation of the dispersed particles.

### A.2. Resin Particle

### A.2.1. Polymeric Shell

The resin particle used in the liquids according to the invention comprises a polymeric shell. If the resin particle comprises a second polymer, this polymer is encapsulated by the polymeric shell.

Preferably, the polymer of the shell is cross-linked. By crosslinking, more rigidity is built into the resin particles allowing a broader range of temperatures and pressures for handling the particles in both the ink making and in the inkjet printing equipment.

Preferred examples of the polymeric shell material include poly(urea), poly(urethanes), poly(esters), poly(carbonates), poly(amides), poly(amines), poly(imines), poly(sulphonamides), melamine based polymers, silica based sol-gel polymers or mixtures thereof such as in U.S. Pat. No. 603,149B1, with polyureas and polyurethanes being especially preferred, polyurea being the most preferred.

The polymeric shell is preferably obtainable by reacting a polyamine comprising at least two primary or secondary amines, with a compound containing at least two functional groups capable of reacting with the primary and secondary amines of the polyamine. Preferably the functional groups are an epoxide, an isocyanate, a β-keto-ester, a β-keto-amide, an anhydride, a 1,3-diketone, a chloroformate, a sulfochloride, an acid halide, an enol ester, an oxalate ester or an aziridine.

Other preferred functional groups are acid halides, chloroformates, enol esters, oxalate esters, N-hydroxysuccinimide active esters, t-butyl carbamates/carbonates, and other active esters. Examples of active ester chemistry is described in Major Methods of Peptide Bond Formation, Chapter 3—Active Esters in Peptide Synthesis, The Peptides: Analysis, Synthesis, Biology, 1979, Pages 105-196 by Miklos Bodanszky. Some examples of useful reagents are: Adipoyl chloride (CAS number 111-50-2), Phthaloyl chloride (CAS number 88-95-9), Diphenoyl dichloride (CAS number 7535-15-1), 3,3′-[[2,2-Bis[(3-chloro-3-oxopropoxy)methyl]-1,3-propanediyl]bis(oxy)]bis[propanoyl chloride] (CAS number 132491-88-4), 3,3′-[2-[(3-chloro-3-oxopropoxy)methyl]-2-ethyl-1,3-propanediyl]bis(oxy)]bis-propanoyl chloride (CAS nr. 78799-44-7), 2,4,6-trioxo-1,3,5-triazine-1,3,5 (2H,4H,6H)-tripropanoyl chloride (CAS nr. 33919-40-3), Tricyclo[3.3.1.13,7]decane-1,3,5-tricarbonyl trichloride (CAS nr. 753025-22-8), Oxydiethylene bis(chloroformate) (CAS nr. 106-75-2), 1,4-Butylene glycol bis(chloroformate) (CAS nr. 2157-16-6), Trimethylolpropane tris(chloroformate) (CAS nr. 14031-47-1). Polymeric curing agents having active ester groups are also commercially available e.g. from Dai Nippon Ink & Chemicals, eg. Epiclon EXB 9451 (Cas nr. 931106-68-2) and Epiclon HPC 8000-65T (CAS nr. 1352138-02-3). Active ester based initiators to prepare (co) polymers having an active ester group capable of reacting with the polyamine curing agent, e.g. as the structure described in patent JP2001206946. Copolymer of an active ester functional monomer such as: NHS-PEO8-maleimide (CAS nr. 289888-73-9). Condensation copolymers of Diglycolic acid chloride (CAS nr. 21062-20-4). Copolymers of sulfonyl chloride monomers such as: 2-propenesulfonyl chloride and p-styrenesulfonyl chloride.

Different chemistries can be used as suitable polyisocyanates. Preferably, the polyamine comprising at least two primary or secondary amines and a quaternary ammonium group, is reacted with an organic solvent soluble isocyanato based resin, such as a polyisocyanate (e.g. biuret, allophanate or isocyanurate trimer based structures). For obtaining a good reactivity and crosslink density, biuret functional polyisocyanates such as Desmodur N3200 or Desmodur N75 BA are preferred.

The chemistry of the polyisocyanate has a significant effect on the particle formation during the high shear treatment and interfacial polymerization. The type of polyisocyanate used influences e.g. reactivity towards the polyamine, the solubility in the organic solvent and the viscosity. Suitable polyisocyanates are monomeric isocyanates, biuret structures, urethione, allophanate, isocyanurate trimer, isocyanate adducts or (partially) modified polyisocyanates.

Examples of modified polyisocyanates are hydrophilic isocyanates such as polyether modified polyisocyanates, e.g Bayhydur 3100, Bayhydur 305, Bayhydur XP2451/1. The type of isocyanate present in the polyisocyanate is also important for the adhesion properties of the pre-treatment composition to the substrate and the physical properties of the overcoat varnish. Hexamethylene diisocyanate (HDI) offers a higher flexibility than isophorone diisocyanate (IPDI) isocyanates.

Optimized properties can be obtained using polyisocyanates based on mixtures of monomeric isocyanates, such as mixtures of HDI and IPDI. The polyisocyanates can be based on the following monomeric isocyanates: isophorone diisocyanate (IPDI), 4,4′-dicyclohexylmethane diisocyanate (H12MDI), 2,4,4′-trimethyl-1,6-hexamethylene diisocyanate (TMDI), hexamethylene diisocyanate (HMDI), pentamethylene diisocyanate (PDI), tolylene diisocyanate (TDI), xylene diisocyanate (XDI) and diphenylmethane diisocyanate (MDI). Modified polyisocyanates can also be used. Examples are reaction products with alcohols, such as TMP (=trimethylol propane) or alcohol terminated polymers.

Other suitable isocyanate containing compounds are isocyanato monomer based copolymers prepared by radical copolymerization. The copolymerization can be performed in the organic solvent which is used to make the oleophilic phase. Suitable monomers to make an isocyanato functional copolymer via addition polymerization are e.g. isocyanatoethylmethacrylate, 2-isocyanatoethyl acrylate, 3-isocyanatopropyl 2-propenoate and 1-(1-Isocyanato-1-methylethyl)-3-isopropenylbenzene (TMI monomer from Allnex). A copolymer of methylmethacrylate and 1-(1-Isocyanato-1-methylethyl)-3-isopropenylbenzene can be obtained in ethyl acetate and consequently can be used in the preparation of the resin particle dispersion of the invention.

In another preferred embodiment, the compound reacting with the polyamine comprising at least two primary or secondary amines, are epoxy containing resins. Examples are bisphenol A diglycidyl ether based epoxy resins, copolymers of epoxy functional monomers such as glycidyl methacrylate (GMA), glycidyl acrylate, allyl glycidyl ether, 4-vinylcyclohexene oxide or (3,4-epoxycyclohexyl)methyl acrylate and epoxydised oils, such as epoxidized soybean oil.

In another embodiment of the invention, the compound reacting with the polyamine comprising at least two primary or secondary amines and a quaternary ammonium group, are polyazeridines. Suitable polyazeridines are NeoAdd Pax 521 (ie. a 80% solution in ethyl acetate) supplied by Covestro and polyazeridines as described in the patent application WO 2020/020714 by DSM IP Assets B.V.

In another embodiment of the invention, the compound reacting with the polyamine comprising at least two primary or secondary amines and a quaternary ammonium group, are alkoxy silane functional polymers such as SiliXan Lab 1039 M1 supplied by SiliXan GmbH (50% in butyl acetate) and copolymers of siliane monomers. Suitable silane monomers are 3-(Trimethoxysilyl)propyl methacrylate, supplied under the trade name Dynasilan MEMO (Evonik), Geniosil GF31 (Momentive), KBM-503 (Shin Etsu Silicones), vinyl trimethoxy silane, Geniosil XL10 (Momentive), acryloxypropyltrimethoxysilane, methacryloxypropyltriethoxysilane, 3-acryloxypropyltriethoxysilane, methacryloxypropyltriisopropoxysilane, ethacryloxymethyl)trimethoxysilane, methacryloyloxymethyltriethoxysilane, 3-[tris(2-methoxyethoxy)silyl]propyl 2-methyl-2-propenoate, 4-oxo-4-[3-(triethoxysilyl)propyl]amino]-2-butenoic acid, 2-methyl-N-[3-(triethoxysilyl)propyl]-2-propenamide, N-[3-(Trimethoxysilyl)propyl]-2-propenamide, (3-acryloxypropyl)methyldimethoxysilane, 3-(Diethoxymethylsilyl)propyl 2-propenoate, (dimethoxymethylsilyl)methyl ester, vinyltriethoxysilane, Vinylmethyldimethoxysilane, vinyltriisopropoxysilane, vinylmethyldiethoxysilane, 1,3-Diethenyl-1,1,3,3-tetraethoxydisiloxane, (ethenyldiethoxysilyl)benzene, 3-(trimethoxysilyl)-2-propen-1-yl 2-methyl-2-propenoate, 1,3-diethenyl-1,1,3,3-tetramethoxy-disiloxane, 1-Ethenyl-4-(trimethoxysilyl)benzene, 1-Ethenyl-4-(triethoxysilyl)benzene, 1-(diethoxymethylsilyl)-4-ethenylbenzene, Acryloxy-2-hydroxypropyl)-3-aminopropyltriethoxysilane, 1-[3-(triethoxysilyl)propyl]-1H-pyrrole-2,5-dione, (2Z)-4-oxo-4-[[3-(triethoxysilyl)propyl]amino]-2-butenoic acid, N-2-propen-1-yl-N-[3-(triethoxysilyl)propyl]-2-propen-1-amine, 4-oxo-4-[3-(triethoxysilyl)propyl]amino]-2-butenoic acid, 2-propenoic acid, 4-[[3-(trimethoxysilyl)propyl]amino]butyl ester, 2-propenoic acid 9,9-diethoxy-4-oxo-3,10-dioxa-5-aza-9-siladodec-1-yl ester (2Z)-4-[3-(diethoxymethylsilyl)propyl]amino]-4-oxo-2-butenoic acid.

In another embodiment of the invention, the compound reacting with the polyamine comprising at least two primary or secondary amines, can be resins having acrylate or acrylamide groups and which are able to react via a Michael addition. Such resins can be prepared by modification of hydroxyfunctional polymers using isocyanato ethyl acrylate or by modification of maleic anhydride copolymers with an hydroxyfunctional acrylate, such as hydroxybutyl acrylate.

In another embodiment of the invention, the compound reacting with the polyamine comprising at least two primary or secondary amines, can be copolymers of maleic anhydrides. Typical anhydride monomers are maleic anhydride, but also copolymers of other anhydride monomers can be used such as itaconic anhydride or crotonic anhydride.

In another embodiment of the invention, the compound reacting with the polyamine comprising at least two primary or secondary amines, can be copolymers with monomers having an active methylene group, e.g. a β-keto-ester, a β-keto-amide, an anhydride or a 1,3-diketone, such as diacetone acrylamide or 2-(acetoacetoxy)ethyl methacrylate.

The resin particles are preferably present in an aqueous inkjet ink or pre-treatment liquid in an amount of no more than 45 wt. %, preferably between 4 and 25 wt. % based on the total weight of the ink or liquid. It was observed that above 30 wt. % jetting was not always so reliable.

Although the resin particles are dispersed in the aqueous medium of the inkjet liquid, a dispersing group covalently bonded to the polymeric shell can be incorporated to further assure extra colloidal stabilisation.

The dispersing group covalently bonded to the polymeric shell, is preferably selected from the group consisting of a carboxylic acid or salt thereof, a sulfonic acid or salt thereof, a phosphoric acid ester or salt thereof, a phosphonic acid or salt thereof.

The dispersing group covalently bonded to the polymeric shell to be incorporated in a pre-treatment liquid, is preferably selected from the group consisting of a protonated amine, a protonated nitrogen containing heteroaromatic compound, a quaternized tertiary amine, a N-quaternized heteroaromatic compound, a sulfonium and a phosphonium.

Preferably the particle dispersion can be used in a jettable liquid according to the invention such as an inkjet ink, a jettable pre-treatment composition or a jettable overcoat varnish. The resin particles of the aqueous dispersion preferably have an average particle size of no more than 4 μm as determined by dynamic laser diffraction. The nozzle diameter of inkjet print heads is usually 20 to 35 μm. Reliable jetting is possible if the average particle size of the resin particles is five times smaller than the nozzle diameter. An average particle size of no more than 4 μm allows jetting by jetting heads having the smallest nozzle diameter of 20 μm. In a more preferred embodiment, the average particle size of the resin particles is ten times smaller than the nozzle diameter. Hence preferably, the average particle size is from 0.05 to 2 μm, more preferably from 0.05 to 1 μm. When the average particle size of the resin particle is smaller than 2 μm, excellent resolution and dispersion stability with time are obtained.

### A.2.2. Second Polymer

In principle any known second polymer can be incorporated in the resin particle used in the liquids according to the invention. Preferably, the second polymer is soluble in substantial water immiscible organic solvents. In a preferred embodiment, the second polymer is selected from the group consisting of poly(urethane)s and copolymers thereof, acrylics and copolymers thereof, poly(ester)s and copolymers thereof, poly(styrene) s and copolymers thereof, poly(vinyl amide)s and copolymers thereof, poly(olephine)s and copolymers thereof, poly(vinyl alcohol) derivatives and copolymers thereof, poly(acetals) and copolymers thereof, poly(ethers) and copolymers thereof, polyamides and copolymers thereof, poly(imides) and copolymers thereof, poly(imines) and copolymers thereof, polycarbonates and copolymers thereof, poly(vinyl chloride) and copolymers thereof, poly(vinylidene chloride) and copolymers thereof, poly(amic acids) and copolymers thereof, poly(saccharides) and derivatives thereof, cellulose and derivatives thereof and combinations thereof.

Poly(urethanes) and acrylics are particularly preferred. Acrylics are defined as polymeric resins obtained by polymerization or copolymerization of acrylates, methacrylates, acrylamides and methacrylamides.

In a preferred embodiment, the second polymer and a first shell monomer such as a polyisocyanate, are mixed prior to the high shear treatment of the interfacial polymerization. The second polymer should then be preferably soluble in the organic solvents forming the oleophilic phase if interfacial polymerization (see § A.3.) is performed for preparing the resin particles according to the invention. At least the second polymer should have segments which are soluble or swellable in the organic solvents forming the oleophilic phase in the interfacial polymerization.

### A.3. Preparation of the Resin Particle Dispersion

The resin particle dispersion used in the liquids according to the invention can be prepared using both chemical and physical methods. Suitable encapsulation methodologies include complex co-acervation, liposome formation, spray drying and polymerization methods.

In the present invention preferably a polymerization method is used, as it allows the highest control in designing the shell of the resin particles. More preferably interfacial polymerization is used to prepare the polymeric shell of the resin particles of the invention. This technique is well-known and has been reviewed by Zhang Y. and Rochefort D. (Journal of Microencapsulation, 29 (7), 636-649 (2012) and by Salitin (in Encapsulation Nanotechnologies, Vikas Mittal (ed.), chapter 5, 137-173 (Scrivener Publishing LLC (2013)).

In interfacial polymerization, such as interfacial polycondensation, two reactants meet at the interface of the emulsion droplets and react rapidly.

In general, interfacial polymerization requires the emulsion of an oleophilic phase in an aqueous continuous phase or vice versa. The oleophilic phase is preferably obtained by using a substantially water immiscible organic solvent. Each of the phases contains at least one dissolved monomer (the first shell monomer) that is capable of reacting with another monomer (the second shell monomer) dissolved in the other phase. Upon polymerisation, a polymer is formed that is insoluble in both the aqueous and the oleophilic phase. As a result, the formed polymer has a tendency to precipitate at the interface of the oleophilic and aqueous phase, hereby forming a polymeric shell around the dispersed phase, which grows upon further polymerisation. The resin particle dispersion according to the present invention are preferably prepared from an oleophilic emulsion in an aqueous continuous phase.

Typical polymeric shells of the capsules according to the invention and formed by interfacial polymerisation are selected from the group consisting of polyamides, typically prepared from di- or poly-acid chlorides as first shell monomers and di- or oligoamines as second shell monomers, polyurea, typically prepared from di- or oligoisocyanates as first shell monomers and di- or oligoamines as second shell monomers, polyurethanes, typically prepared from di- or oligoisocyanates as first shell monomers and di- or oligoalcohols as second shell monomers, polysulfonamides, typically prepared from di- or oligosulfochlorides as first shell monomers and di- or oligoamines as second shell monomers, polyesters, typically prepared from di- or oligo-acid chlorides as first shell monomers and di- or oligoalcohols as second shell monomers and polycarbonates, typically prepared from di- or oligo-chloroformates as first shell monomers and di- or oligoalcohols as second shell monomers. The shell can be composed of combinations of these polymers.

In a preferred embodiment of the invention, interfacial polymerization is performed and a polyurea shell is formed at the interface. Preferably, the first shell monomer is a polyisocyanate present in the oleophilic phase, while polyamines are present in the aqueous phase as the second shell monomer and which acts as a crosslinker.

Polyamines are preferred whereas polyols show a much slower reaction rate. Alternatively, the second shell monomer can be omitted as water can react with the isocyanate moiety and can form an amine. This in-situ formed amine can then further react with another isocyanate moiety present in the polyisocyanate. So even without adding a second shell monomer a crosslinked polyurea shell can be obtained.

When emulsifying the water immiscible solvent in the aqueous phase, the breaking up of the droplets is dependent on the viscosity of the solvent and water phase. Highest shear forces can usually be applied when the viscosity of the water immiscible solvent and the water phase are close to each other. Therefore, also polyisocyanates having lower molecular weights give better results in reducing the droplet size by high shear. Smaller droplet size of the oleophilic phase (obtained by the water immiscible solvent, the second polymer and the polyisocyanate) lead to particles having a smaller particle size.

The ratio water immiscible solvent/water is also of importance. When adding too much water (>65 wt. %) during the dispersing step, the viscosity is not only lower to obtain higher shear forces but also part of the water immiscible solvent will partially go into the aqueous phase. In case of a second polymer or polyisocyanate having a low solubility in the water immiscible solvent, a too low water immiscible solvent concentration during the high shear dispersing step will result in particles having a greater particle size.

Furthermore, the concentration of the polyisocyanate, the added second polymer if present and in particular, the ratio of water immiscible solvent phase/aqueous phase determines the oleophilic droplet sizes during the high shear treatment. The amount of the isocyanate groups in the polyisocyanate, their reactivity and the concentration of the second shell monomer in the aqueous phase, preferably a polyamine, determines the crosslinking density of the polymeric shell.

The type of solvent forming the oleophilic phase in the interfacial polymerization, is important to obtain an industrial scalable process. Preferably an organic solvent is used with a low boiling point which can be easily removed, such as ethyl acetate or methylene chloride. Preferably the organic solvent has a boiling point lower than that of water.

In a particularly preferred embodiment, the shell is composed of a polyurea or a combination thereof with a polyurethane. In a further preferred embodiment, a substantial water immiscible solvent is used in the dispersion step, which is removed by solvent stripping before or after the shell formation. In a particularly preferred embodiment, the water immiscible solvent has a boiling point below 100° C. at normal pressure. Esters and ketones are particularly preferred as water immiscible solvent.

A substantial water immiscible solvent is an organic solvent having low miscibility in water. Low miscibility is defined as any water solvent combination forming a two phase system at 20° C. when mixed in a one over one volume ratio.

In a preferred embodiment of the invention, the resin particle of the invention comprises a second polymer. This is usually incorporated into the particle by dissolving it in the organic solvent having low miscibility with water and having a lower boiling point than water. A preferred organic solvent is ethyl acetate, because it also has a low flammability hazard compared to other organic solvents.

The method for preparing the dispersion of resin particles used in the liquids according to the invention, preferably includes the following steps:
a) preparing a non-aqueous solution of a first shell monomer for forming the polymeric shell and optionally the second polymer in a substantial water immiscible organic solvent and preferably having a lower boiling point than water;
b) preparing an aqueous solution of the surfactant according to Formula I, II or III and a second shell monomer for forming the polymeric shell;
c) emulsifying the non-aqueous solution under high shear in the aqueous solution;
d) optionally stripping the organic solvent from the mixture of the aqueous solution and the non-aqueous solution; and
e) optionally adding water that is removed during evaporation to obtain a desired capsule concentration; and
f) formation of a polymeric shell by initiating the interfacial polymerization of the first shell monomer with the second shell monomer, e.g. by a temperature increase, the addition of a catalyst, or by UV-irradiation.

The second shell monomer or crosslinker can be added to the emulsion in advance or after the high shear dispersing step. The initiation of the interfacial polymerization happens mostly spontaneously at room temperature, so no initiation is required. The emulsifier can also become part of the polymeric shell when the emulsifier is reactive such as in a preferred embodiment of the invention.

Sometimes, when using self-dispersing second polymers, polyisocyanates or very efficient emulsifiers, the high shear emulsifying step can be performed by normal stirring.

The resin particle dispersion can then be completed into an aqueous inkjet ink, pre-treatment liquid or overcoat varnish, by addition of e.g. colorants, water, humectants, surfactants, solvents and the like.

The resin particles used in the liquids according to the invention are dispersed into an aqueous medium. The aqueous medium consists of water, but may preferably include one or more water-soluble organic solvents.

The one or more organic solvents may be added for a variety of reasons. For example, it can be advantageous to add a small amount of an organic solvent to improve the dissolution of a compound in one of the liquids to be prepared, to obtain better penetration in porous substrates or to prevent fast drying of ink at the nozzle of the inkjet head. Preferable water-soluble organic solvents are polyols (e.g., ethylene glycol, glycerin, 2-ethyl-2-(hydroxymethyl)-1,3-propanediol, tetraethylene glycol, triethylene glycol, tripropylene glycol, 1,2,4-butanetriol, diethylene glycol, propylene glycol, dipropylene glycol, butyleneglycol, 1,6-hexanediol, 1,2-hexanediol, 1,5-pentanediol, 1,2-pentanediol, 2,2-dimethyl-1,3-prapanediol, 2-methyl-2,4-pentanediol, 3-methyl-1,5-pentanediol, 3-methyl-1,3-butanediol, and 2-methyl-1,3-propanediol), N-hydroxyethyl-pyrrolidon, N-butyl-pyrrolidon, amines (e.g., ethanolamine, and 2-(dimethylamino) ethanol), monohydric alcohols (e.g., methanol, ethanol, and butanol), alkyl ethers of polyhydric alcohols (e.g., diethylene glycol monomethyl ether, diethylene glycol monobutyl ether, triethylene glycol monomethyl ether, triethylene glycol monobutyl ether, ethylene glycol monomethyl ether, ethylene glycol monobutyl ether, propylene glycol monomethyl ether, propylene glycol monobutyl ether, and dipropylene glycol monomethyl ether), 2,2′-thiodiethanol, amides such as N,N-dimethylformamide, heterocycles such as 2-pyrrolidone and N-methyl-2-pyrrolidone, and acetonitrile.

### B. Aqueous Pre-Treatment Composition

Aqueous pre-treatment compositions are preferably used in inkjet printing with aqueous based inks onto low-absorbing or non-absorbing substrates such as polymeric substrates, but also onto porous substrates.

The pre-treatment compositions according to the invention preferably comprise the resin particles as claimed in claim 1. Due to the absence of ionic charges in the shell of the resin particles or the presence of cationic charges in the shell, these can be combined with cationic fixing agents without negative effects onto the colloidal stability of the pre-treatment composition.

Without being bound by any theory, it is thought that the resin particles of the invention in a pre-treatment composition provide an excellent ink spreading due to the hydrophilicity and swellability of the core of the resin particles which is surrounded by the crosslinked polymeric shell.

The aqueous pre-treatment composition according to the invention comprises the aqueous dispersion according to the invention and a fixing agent. The fixing agent is preferably a water soluble multivalent metal salt or a cationic polymer. The amount of resin particles of the dispersion according to the invention is from 1 wt. % to 45 wt. %, more preferably from 4 to 25 wt. % based on the total weight of the pre-treatment composition. It was observed that above 45 wt. %, jetting was not always reliable. If the amount of resin particles is below 1 wt. %, the improvement in ink spreading and water resistance of the images is hardly noticeable.

The polyvalent metal salt may be present in the pre-treatment composition to improve inkjet print quality. Generally, the polyvalent metal salt may be any water-soluble polyvalent metal salt. In specific examples, the polyvalent metal salt may include calcium chloride (CaCl₂)), magnesium chloride (MgCl₂), magnesium sulfate (MgSO₄), aluminium chloride (AlCl₃), calcium nitrate (Ca(NO₃)₂), magnesium nitrate (Mg(NO₃)₂), magnesium acetate (Mg(CH₃COO)₂), zinc acetate (Zn(CH₃COO)₂) calcium propionate (Ca(C₂H₅COO)₂), or a combination thereof. In further examples, the polyvalent metal salt may include a metal cation selected from calcium, copper, nickel, magnesium, zinc, barium, iron, aluminium, chromium, or another polyvalent metal.

The polyvalent metal salt may also include an anion. In some examples, the anion may be fluoride, chloride, iodide, bromide, nitrate, chlorate, sulfate, acetate, or RCOO⁻ where R is hydrogen or any low molecular weight hydrocarbon chain, e.g., C1 to C12. In a more specific example, the anion may be a carboxylate derived from a saturated aliphatic monocarboxylic acid having 1 to 6 carbon atoms or a carbocyclic monocarboxylic acid having 7 to 11 carbon atoms. Examples of saturated aliphatic monocarboxylic acid having 1 to 6 carbon atoms may include formic acid, acetic acid, propionic acid, butyric acid, isobutyric acid, valeric acid, isovaleric acid, pivalic acid, and/or hexanoic acid. The cationic salt may also be a mixture of two or more different cationic salts.

In some cases, the polyvalent metal salt may be present in an amount from 1 wt. % to 99 wt. % with respect to the entire weight of the solids in the pre-treatment composition. In more specific examples, the polyvalent metal salt may be present in an amount from 5 wt. % to 65 wt. %, more preferably from 25 wt. % to 60 wt. %, with respect to solids content of the pre-treatment composition. If the amounts are below the lower limits, insufficient fixing of the colorants occur resulting in a reduced image quality.

Polymeric cationic polymers, suitable as fixing agent in the pre-treatment composition contain either guanidinium or fully quaternized ammonium functionalities, such as quaternized polyamine copolymers. Generally, the weight average molecular weight (Mw) of the cationic polymer allows viscosity less than 25 cP at 25° C., as measured on a Brookfield viscometer. Typical Mw are less than 500.000, and in one aspect, less than 50.000.

Suitable classes of cationic polymers that can be used include, but are not limited to, quaternized polyamines, dicyandiamide polycations, diallyldimethyl ammonium chloride copolymers, quaternized dimethylaminoethyl (meth)acrylate polymers, quaternized vinylimidizol polymers, alkyl guanidine polymers, alkoxylated polyethylene imines, and mixtures thereof.

The pre-treatment composition may also contain pigments. Particularly useful for printing on dark or transparent substrates, is a pre-treatment liquid containing a white pigment. The preferred pigment for the aqueous pre-treatment liquid is titanium dioxide. Titanium dioxide (TIO₂) pigment useful in the present invention may be in the rutile or anastase crystalline form. Processes for making TiO₂ are described in greater detail in “The Pigment Handbook”, Vol. I, 2nd Ed., John Wiley & Sons, NY (1988), the relevant disclosure of which is incorporated by reference herein for all purposes as if fully set forth.

The titanium dioxide particles can have a wide variety of average particle sizes of about 1 micron or less, depending on the desired end use application of the pre-treatment liquid. For applications demanding high hiding or decorative printing applications, the titanium dioxide particles preferably have an average size of less than about I μm. Preferably, the particles have an average size of from about 50 to about 950 nm, more preferably from about 75 to about 750 nm, and still more preferably from about 100 to about 500 nm.

For applications demanding white colour with some degree of transparency, the pigment preference is “nano” titanium dioxide. “Nano” titanium dioxide particles typically have an average size ranging from about 10 to about 200 nm, preferably from about 20 to about 150 nm, and more preferably from about 35 to about 75 nm. A pre-treatment composition comprising nano titanium dioxide can provide improved chroma and transparency, while still retaining good resistance to light fade and appropriate hue angle. A commercially available example of an uncoated nano grade of titanium oxide is P-25, available from Degussa (Parsippany N.J.).

In addition, unique advantages may be realized with multiple particle sizes, such as opaqueness and UV protection. These multiple sizes can be achieved by adding both a pigmentary and a nano grade of TiO₂.

The titanium dioxide is preferably incorporated into the pre-treatment formulation via a slurry concentrate composition. The amount of titanium dioxide present in the slurry composition is preferably from about 15 wt. % to about 80 wt. %, based on the total slurry weight.

The titanium dioxide pigment may also bear one or more metal oxide surface coatings. These coatings may be applied using techniques known by those skilled in the art. Examples of metal oxide coatings include silica, alumina, aluminasilica, boria and zirconia, among others. Metal oxide coatings of alumina, aluminasilica, boria and zirconia result in a positive charged surface of the TiO₂ pigments.

Commercial examples of such coated titanium dioxides include R700 (alumina-coated, available from E.I. DuPont deNemours, Wilmington Del.), RDI-S (alumina-coated, available from Kemira Industrial Chemicals, Helsinki, Finland), R706 (available from DuPont, Wilmington Del.) and W-6042 (a silica alumina treated nano grade titanium dioxide from Tayco Corporation, Osaka Japan).

### C. Overcoat Varnish Composition

An overcoat varnish is used in inkjet printing for increasing the durability of inkjet printed images. The varnish composition according to the invention comprises water, the aqueous dispersion of the invention and preferably a co-solvent. The varnish composition can also obtain wax particles, surfactants, biocides, surface active agents to influence the friction coefficient, . . . . The overcoat varnish is applied onto at least the printed images via a coating technique or a jetting technique.

The amount of resin particles of the dispersion according to the invention in the overcoat varnish is from 1 wt. % to 45 wt. %, more preferably from 4 to 25 wt. % based on the total weight of the varnish composition. It was observed that above 45 wt. %, jetting was not always reliable. If the amount of resin particles is below 1 wt. %, the improvement in durability of the images is hardly noticeable.

### D. Inkjet Ink

The aqueous ink jet inks according to the invention comprise the resins of claim 1 together with a colorant. The resin particles of the dispersion are preferably present in the inkjet ink in an amount of no more than 30 wt. %, preferably between 5 and 25 wt. % based on the total weight of the ink. Any colorant may be suitable, but organic or inorganic pigments having a positively charged surface are particularly suitable. Examples of such inorganic pigments are white pigments based on TiO₂ as described in § B. Other suitable inorganic pigments are iron-oxide or chrome-oxide based pigments.

The pigments may be black, white, cyan, magenta, yellow, red, orange, violet, blue, green, brown, mixtures thereof, and the like. A colour pigment may be chosen from those disclosed by HERBST, Willy, et al. Industrial Organic Pigments, Production, Properties, Applications. 3rd edition. Wiley-VCH, 2004. ISBN 3527305769.

### E. Inkjet Recording Method

The liquids according to the invention may be a pre-treatment composition, an inkjet ink or in an overcoat varnish and can be used in an inkjet recording method.

The inkjet recording method according to the invention is suitable for making images on following substrates.

The substrate in the inkjet recording method may be porous, such as e.g. textile, paper and leather, but may also be low-absorbing such as card board substrates or non-absorbing such as polyethylene, polypropylene, polycarbonate, polyvinyl chloride, polyesters like polyethylene terephthalate (PET), polyethylene naphthalate (PEN), polylactide (PLA), polymethylmethacrylate or polyimide.

The substrate may also be a paper substrate, such as plain paper or resin coated paper, e.g. polyethylene or polypropylene coated paper. There is no real limitation on the type of paper and it includes newsprint paper, magazine paper, office paper, wallpaper but also paper of higher grammage, usually referred to as boards, such as white lined chipboard, corrugated board and packaging board.

The substrates may be transparent, translucent or opaque. Preferred opaque substrates includes so-called synthetic paper, like the Synaps™ grades from Agfa-Gevaert which are an opaque polyester sheet having a density of 1.10 g/cm³ or more.

### E.1. Application Method of the Pre-Treatment Composition

The pre-treatment composition according to the present invention is suitable for treating different substrates, porous and non-porous ones. The treatment by the pre-treatment composition containing the aqueous dispersion according to the invention, provides a fixing of the colorants of an ink which is jetted onto the applied pre-treatment composition to form the printed image. The fixing strongly limits the colour bleeding, increases the sharpness of the image and increases the water and solvent resistance of the printed images. The pre-treatment composition containing the aqueous dispersion according to the invention provides a good spreading of the inkjet ink which is jetted onto the applied pre-treatment composition.

Porous substrates include paper, card board, white lined chipboard, corrugated board, packaging board, folding board, wood, ceramics, stone, leather and textile. Non-porous substrates include metal, glass, polypropylene, polyvinylchloride, PET, PMMA, polycarbonate, polyamide, polystyrene or co-polymers thereof. The papers can be a single layer of a multilayer paper.

The paper may be brown Kraft, White Top or bleached board. The paper may be manufactured from chemical, wood, or recycled fibre. As an example, the paper may be a liner intended for printing on page wide web presses and converted into corrugated boxes. In this aspect, the liner paper may be used as a double face liner and may be converted directly in a corrugator or laminated onto a double face liner after corrugation. The paper may also be boards used for boxes and other packaging applications.

The pre-treatment composition is particularly suited for being jetted onto substrates, such as the one intended for packaging applications.

One of the reasons is that the resin particles of the aqueous dispersion according to the invention do not show film formation in inkjet head nozzles and supply equipment. A high jetting reliability is hence achieved.

All well-known conventional methods can be used for coating or impregnating the substrate by the pre-treatment composition. Examples of the method include air knife coating, blade coating, roll coating, gravure coating, flexographic printing and spraying. More preferably the pre-treatment composition is applied by means of a jetting technique, such as an inkjet technique. The pre-treatment composition is then preferably applied using an ink jet head or valve jet head.

This means of applying the pre-treatment composition, which is preferably according to an image, has the advantage that the amount of required pre-treatment composition is substantially lower than with the other application methods. This reduces material cost and decreases the required time for drying the applied amount of pre-treatment composition.

Suitable ink jet head types for applying the pre-treatment composition are piezoelectric type, continuous type, thermal print head type, Memjet-type or valve jet type.

After applying the pre-treatment composition onto a substrate, the coating is preferably at least partially dried before printing the image onto the treated substrate.

Substrates to which the pre-treatment composition has been applied may be dried and optionally undergo a heat treatment, before the subsequent ink jetting step with the colorant containing ink.

Examples of the heating process to dry the pre-treatment composition according to the invention include, but are not limited to, heat press, atmospheric steaming, high-pressure steaming, THERMOFIX. Any heat source can be used for the heating process; for example, an infrared ray source is employed.

The drying step can be performed at the air, but the heating step must be performed by using heat sources; examples include equipment for forced-air heating, radiation heating such as IR-radiation, including NIR-, CIR- and SWIR radiation, conduction heating, high-frequency drying, and microwave drying

In another preferred embodiment of the invention, the pre-treatment composition, is not substantially dried before the image is printed by means of the jetting of the aqueous ink jetting step.

### E.2. Ink Jetting & Drying

After the application of the pre-treatment composition to the substrate, an aqueous inkjet ink comprising a colorant is applied to the substrate, preferably onto the parts where the pre-treatment composition has been applied on. The colorant is preferably a pigment. A preferred method of applying the aqueous inkjet ink is by means of an ink jetting technique.

A preferred ink jet head for the jetting of the inkjet ink is a piezoelectric ink jet head. Piezoelectric inkjet jetting is based on the movement of a piezoelectric ceramic transducer when a voltage is applied thereto. The application of a voltage changes the shape of the piezoelectric ceramic transducer in the print head creating a void, which is then filled with pre-treatment composition. When the voltage is again removed, the ceramic expands to its original shape, ejecting a drop of ink from the ink jet head.

The jetting of the aqueous inkjet ink is not restricted to piezoelectric inkjet printing. Other inkjet print heads can be used and include various types, such as a continuous type, a thermal print head type, a Memjet-type of head and a valve jet type.

Examples of the heating process to dry the inkjet ink according to the invention are listed in § E.1.

The drying step is such that a temperature of the printed images is preferably obtained below 150° C.

### E.3 Application Method of the Overcoat Varnish

In another preferred inkjet recording method, following steps are comprised: a) jetting an aqueous inkjet ink onto a substrate, the ink comprising a colorant preferably a pigment; and b) optionally drying the jetted inkjet ink; and c) applying an over coat varnish comprising water and the aqueous dispersion according to the invention; and d) drying the applied over coat varnish. If step b) was not performed, the drying in step d) should be performed by applying heat such that the temperature of the applied ink is of at least 50° C., more preferably at least 80° C.

In a more preferred inkjet recording method, a pre-treatment composition may be applied before step a). More preferably, the pre-treatment composition comprises the aqueous dispersion according to the invention. The pre-treatment liquid is preferably jetted by means of an inkjet head.

In another preferred inkjet recording method, the overcoat varnish is applied via a technique selected from the group of ink jetting, valve jetting and spraying. More specifically, these techniques of ink jetting and valve jetting allow, the over coat varnish according to the invention to be applied image wise. This has the advantage that the amount of applied liquid required is substantially lower than with the other application methods. This reduces material cost and decreases the required time for drying the applied amount of over coat varnish. Other advantage is that differences in physical properties such as gloss or preventing application of over coat varnish onto parts to be glued can be achieved by applying the varnish image wise.

The jetting and drying of the over coat varnish can be performed as described in § E.1.

### F. Examples

### F.1. Materials

All materials used in the following examples were readily available from standard sources such as Aldrich Chemical Co. (Belgium) and Acros (Belgium) unless otherwise specified. Where used, water is demineralised water.
PB15: 3 is Hostaperm™ B4G-KR, a C.I. Pigment Blue 15:3 pigment from CLARIANT.
Edaplan is an abbreviation used for Edaplan™ 482, a polymeric dispersant from MUNZING CHEMIE GmbH.
Proxel is a 5 wt. % aqueous solution of 1,2-benzisothiazolin-3-one available as Proxel™ K from YDS CHEMICALS NV.
Liquilube 404E is a 35 wt. % aqueous HDPE wax dispersion from Lubrizol
Styron HPX94 is 54 wt. % aqueous dispersion of a poly(styrene butadiene) from Styron Europe
Surfynol 104PG50 is a 50 wt. % solution of 2,4,7,9-Tetramethyl-5-decyne-4,7-diol in propylene glycol from Evonik
Aquacer 530 is an aqueous dispersion containing 32 wt. % oxidized HDPE wax from BYK
Synperonic PE P105 is a PEO/PPO co-polymeric dispersant having an average Mw of 6500 g/mol and a PPO/PEO weight ratio of approximately 1.00 from Croda
Kauropal K933 is a non-ionic oxirane, mono(2-propylheptyl) ether from BASF
Tego Foamex 822 is a polyether siloxan copolymer from Evonik
Desmodur N75 BA is a HDI biuret based polyisocyanate 75% dissolved in butylacetate from Covestro
Desmodur N3200 is an HDI based polyisocyanurate supplied by Covestro
Dynacol 7150 is a polyester polyol supplied by Evonik
Ymer N90 is a-[2,2-bis(hydroxymethyl)butyl]-ω-methoxy-poly(oxy-1,2-ethanediyl), and is supplied by Perstorp
Reaxis C708 is a catalyst supplied by Reaxis BV, The Netherlands
Vestanat IPDI is isophorone diisocyanate and is supplied by Evonik
Ethomeen C25 is a 100 wt. % coco amine ethoxylate produced by Nouryon.
Disponil A1580 is a lauryl ethoxylate having an average degree of ethoxylation of 15 EO units.
MPEG 4000 is a polyethylene glycol monomethyl ether 4000 supplied by TCI.
PU-1 is a 42.98 wt. % polyurethane solution in ethyl acetate and is prepared as follows: 260.08 g. of Dynacol 7150 is dissolved in 402.9 g. of ethyl acetate at 45° C. in an Erlenmeyer. 56.87 g. of Ymer N90 is added to the Dynacol solution. Whereas Ymer N90 is a wax, it is preheated at 90° C. in order to become liquid and more easy to handle. The mixture of Ymer N90 and Dynacol 7150 is mixed and a clear solution in ethyl acetate is obtained. The solution is allowed to cool to room temperature. A catalyst solution is prepared by dilution of 2.14 g. of Reaxis C708 with 19.34 g. of ethyl acetate. The polyol solution is transferred to a 1000 mL three-necked round-bottom flask equipped with a coiled condenser and an overhead stirrer. The flask is flushed with nitrogen and slow nitrogen flow is maintained during stirring and reaction. Subsequently the catalyst was added dropwise via an addition funnel with pressure equalization arm. The oil bath was heated to 75° C. After 1 hour, the reaction mixture reaches a constant temperature of about 68° C. Subsequently 31.32 g. of Vestanat IPDI is added via an addition funnel with pressure equalization arm during 35 minutes. The oil bath is put to 70° C. and the reaction is allowed to react during 19 hours. After reacting, the oil bath is put again to 75° C. for 30 minutes and then cooled to room temperature. The theoretical solids content is 42.98 wt. %.

### F.2. Preparation of Aqueous Resin Dispersions

### F.2.1. Preparation of a Resin Particle Dispersion COMP-PD1

In this resin particle dispersion, the same non-ionic surfactant (=polyethylene glycol monomethyl ether 4000) was used as in the preparation of the microcapsule dispersions of EP 3 564 318A1.

The oleophilic phase is prepared by mixing: 23.99 g. of ethyl acetate, 8.53 g. of Desmodur N3200, 2.7 g. of MPEG 4000 and 19.858 g. of PU-1. An aqueous phase is prepared by mixing: 0.93 g. of lysine and 52.45 g. of water. The interfacial polymerization is performed the same way as described in § F.2.3. However, during the heating step to 60° C., the dispersion flocculates and no stable aqueous dispersion is obtained.

### F.2.2. Preparation of a Resin Particle Dispersion COMP-PD2

In this resin dispersion, a lauryl ethoxylate having one polyethylene chain with an average degree of ethoxylation of 15 EO units, was used to stabilize the resin particles.

The oleophilic phase is prepared by mixing: 24.56 g. of ethyl acetate, 8.535 g. of Desmodur N3200, 2.7 g. of MPEG 4000 and 19.858 g. of PU-1. An aqueous phase is prepared by mixing: 3.62 g. of Disponil A1580, 0.93 g. of lysine and 53.32 g. of water. The interfacial polymerization is performed the same way as described in § F.2.3.

The resulting resin particle dispersion has an average particle size of 3174 nm and a polydispersity of 0,689. Due to this high particle size and broad particle size distribution, this dispersion could not be used to prepare a jettable pre-treatment composition.

### F.2.3. Preparation of a Resin Particle Dispersion INV-PD1

The INV-PD1 dispersion was prepared via interfacial polymerization wherein the oleophilic phase comprises an HDI Biuret based polyisocyanate and a polyurethane-polyethylene glycol graft copolymer. The PU/polyisocyanate weight ratio in the obtained resin particle is 50/50.

The oleophilic phase is prepared by mixing: 24.56 g. of ethyl acetate, 8.535 g. of Desmodur N3200 and 19.858 g. of PU-1. An aqueous phase is prepared by mixing: 3.62 g. of Ethomeen C25, 0.931 g. of lysine and 50.379 g. water. The ethyl acetate solution (=oleophilic phase) is brought in a plastic bottle of 250 ml, having a wide opening and placed in an ice bath in order to cool the solution. The aqueous solution (=aqueous phase) is added to the oleophilic phase which is emulsified in the aqueous phase by means of an Utraturrax device at 18000 RPM during 5 minutes. The emulsion is brought in a round bottom flask. In order to transfer everything, the plastic bottle is rinsed with 50.00 g. of water. The ethyl acetate of the emulsion is evaporated on a rotary evaporator until a weight of 75 g. The temperature was set to 40° C. and the ethyl acetate was removed under reduced pressure. Evaporation was started at a pressure of 200 mbar and was decreased gradually till 40 mbar. The round bottom flask is placed in an oil bath at 40° C. and is heated to 60° C. The obtained resin particle dispersion is kept at 60° C. during 16 hours and then cooled to room temperature. The resulting dispersion has a solids content of 28.35 wt. %, the Z-average particle size is 272.1 nm (determined by a Malvern particle sizer), a polydispersity of 0,208 and the pH of the microcapsule dispersion is 6.97.

### F.3. Evaluation Methods

### F.3.1. Image Quality

Pre-treatment compositions comprising the above resin particle dispersion, were applied onto a coated corrugated liner XLHD MM X-Liner HD (180 g/m²) from MM Karton using a 4 μm spiral bar. The coated liner was dried at 60° C. in an oven for 2 minutes.

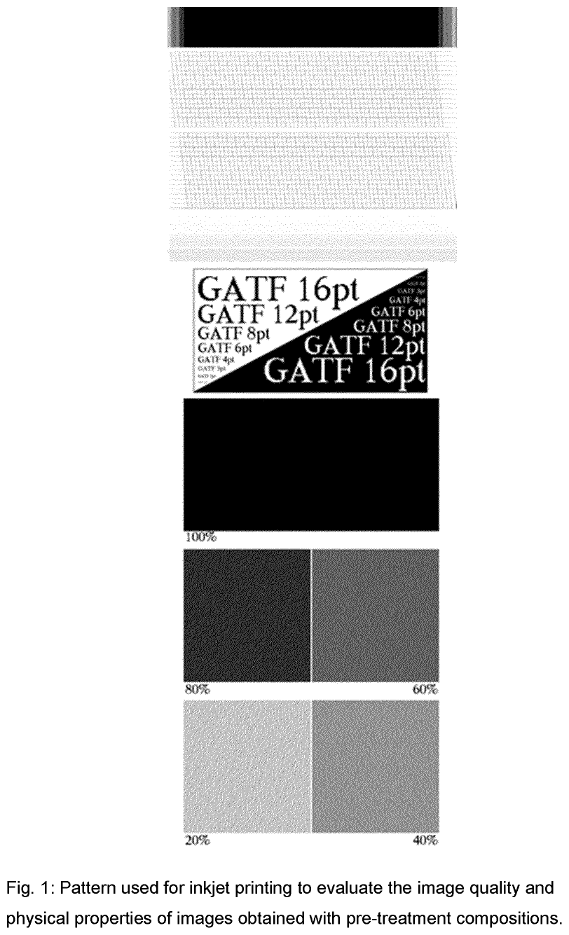

After drying the pre-treatment compositions, the coated liner was printed by means of an ImageXpert JetXpert with GIS print head driving electronics for FujiFilm Dimatix Samba print head (Samba G3L). An aqueous cyan ink was printed with a drop volume between 5.4-6.5 μl at a voltage between 19.5-23.5 V at 32° C. and with a firing frequency of 7.8 kHz. The printed images were dried at 60° C. for 2 minutes in an oven. The pattern of the print is shown in FIG. 1.

The image quality of the print was evaluated by visually analysing the following three properties: 1) ink spreading; 2) ink fixing and 3) image sharpness.

Ink spreading: the ink should completely cover the solids in the printed image. A lack of ink spreading is demonstrated by the appearance of white lines in the solid areas. The evaluation was conducted by visually observing the solid areas and by giving a score from 0 (=excellent ink spreading, complete coverage) to 3 (=poor ink spreading, more than 20 white lines visible in the solid area).

Ink fixing: the ink should homogenously and intensely cover the solids in the printed image. A lack of ink fixing is demonstrated by the appearance of uneven patterns in the solid areas. The ink fixing was evaluated by visually observing the solid areas and by giving a score from 0 (=excellent ink fixing, homogeneous coverage) to 3 (=poor ink fixing, strong unevenness observable).

Image sharpness: the fine text should be readable. A lack of image sharpness is demonstrated by the disappearance of negative text. The image sharpness was evaluated by visually observing the negative texts and by giving a score from 0 (=excellent image sharpness, 6 pt clearly readable) to 3 (=poor image sharpness, 16 pt partially or totally covered by ink).

### F.3.2. Water Resistance

The water resistance of the prints was evaluated by measuring the CIELAB ΔE after the water resistance tests.

The water resistance was evaluated by rubbing the solid areas with a wetted cotton swab, 10 double strokes. The ΔE of the image was calculated by comparing the CIELAB E values of the solid areas of the printed image before and after the wet rub.

The evaluation of the water resistance is according to the criteria as shown in Table 1. A good pre-treatment composition should provide acceptable levels of water resistance.

TABLE 1
Scoring figures of the water resistance measurement.

| Scoring | Water resistance |
|---|---|
| 0 (Excellent) | ΔE < 10 |
| 1 (Good) | 10 ≤ ΔE < 20 |
| 2 (Moderate) | 20 ≤ ΔE < 40 |
| 3 (Poor) | ΔE >=40 |

### F.4. Preparation of Pre-Treatment Compositions

The pre-treatment compositions were prepared by mixing the ingredients given in Table 2. The comparative pre-treatment composition (COMP-PC) included a polystyrene butadiene latex, while the inventive pre-treatment composition included the inventive dispersion INV-DP1. The weight percentages are relative to the total weight of the pre-treatment compositions. The raw materials were used as supplied without any further treatments. White opaque liquids were obtained.

TABLE 2
Pre-treatment compositions

| | Amount in wt. % | |
|---|---|---|
| Compound | COMP-PC | INV-PC1 |
| Styron HPX94 | 9.91 | — |
| INV-DP1 | — | 18.80 |
| Mg(NO₃)₂•6H2O | 11.25 | 10.0 |
| Kauropal K933 | 0.04 | 0.04 |
| Tego Foamex 822 | 0.04 | 0.04 |
| Aquacer 530 | 8.0 | 8.0 |
| Synperonic PE P105 | 1.0 | 1.0 |
| Propylene glycol | 18.0 | 18.0 |
| 1,2-hexanediol | 2.85 | 2.85 |
| D.I. water | To complete to 100% | To complete to 100% |

### F.5. Preparation of Aqueous Inkjet Ink

In a first step, a concentrated aqueous pigment dispersion was made by mixing the pigment PB15:3, with the dispersant Edaplan using a Disperlux™ Yellow mixer and milled using a Dynomill™ KDL with 0.04 mm yttrium stabilized zirconium beads YTZ™ Grinding Media (available from TOSOH Corp.). After milling, the dispersion is separated from the beads. The concentrated aqueous pigment dispersion served as the basis for the preparation of the inkjet inks.

An aqueous cyan ink was prepared by diluting the concentrated pigment dispersion with the other ink ingredients according to Table 3 expressed in wt. % based on the total weight of the ink. Water was added to complete the ink to the desired pigment concentration.

TABLE 3
Aqueous inkjet ink

| Component | Amount (wt. %) |
|---|---|
| PB15:3 | 3.0 |
| Edaplan | 1.5 |
| Proxel | 0.2 |
| 1,2-hexanediol | 3.00 |
| Surfynol 104PG50 | 0.4 |
| Propylene glycol | 36.00 |
| Liquilube 404 E | 2.86 |
| Water | 53.04 |

The performance of different pre-treatment compositions onto the image quality and water resistance is listed in Table 4.

TABLE 4
Image quality and water resistance of printed images onto
comparative and inventive pre-treatment compositions

| | No pre- | COMP- | |
|---|---|---|---|
| Pre-treat comp. | treatment | PC | INV-PC1 |
| Ink spreading | 1 | 2 | 0 |
| Ink fixing | 3 | 3 | 0 |
| Image sharpness | 0 | 0 | 0 |
| Water resistance | 0 | 2 | 0 |

It can be seen from Table 4, that the pre-treatment composition containing the aqueous resin particle dispersion containing a surfactant according to Formula I, does improve image quality in terms of ink spreading and ink fixing. The physical properties such as water resistance of the print with the inventive resin particle dispersion, showed no negative effects with respect to no pre-treated sample.

1-13. (canceled)

14. A pre-treatment composition for inkjet printing, comprising water, a water-soluble fixing agent, and an aqueous dispersion comprising a surfactant according to Formula I, II, or III and a resin particle comprising a crosslinked polymeric shell, the polymeric shell comprises a polymer selected from the group consisting of poly(urea), poly(urethanes), poly(amides), poly(amines), poly(imines), poly(esters), poly(carbonates), poly(sulfonamides), and combinations thereof, 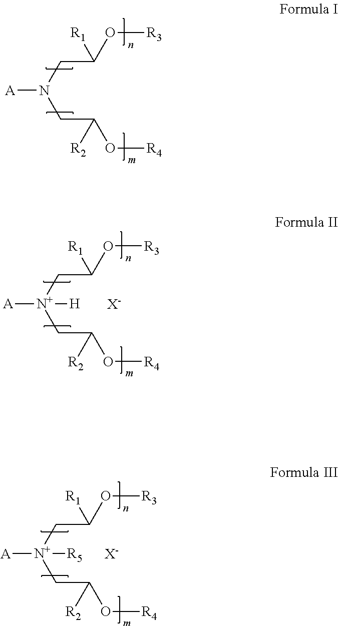
wherein
$$n + m \geq 2 ,$$
R₁ and R₂ are H, CH₃, or CH₂OH,
R₃ and R₄ are H, substituted or unsubstituted alkyl group, or a substituted or unsubstituted alkenyl group,
R₅ is a substituted or unsubstituted alkyl group, a substituted or unsubstituted alkenyl group, a substituted or unsubstituted alkynyl group, a substituted or unsubstituted aralkyl group, or a substituted or unsubstituted alkaryl group, and
A is a substituted or unsubstituted alkyl group.

15. The pre-treatment composition of claim 14, wherein the polymeric shell is obtained by reaction between a polyamine comprising at least two primary or secondary amines and a compound comprising at least two functional groups selected from the group consisting of an epoxide, an isocyanate, a β-keto-ester, a β-keto-amide, an anhydride, a 1,3-diketone, a chloroformate, a sulfochloride, an acid halide, an enol ester, an oxalate ester, and an aziridine.

16. The pre-treatment composition of claim 14, wherein the resin particle comprises a second polymer.

17. The pre-treatment composition of claim 15, wherein the resin particle comprises a second polymer.

18. The pre-treatment composition of claim 16, wherein the second polymer is an oligomer or polymer selected from the group consisting of poly(urethanes) and copolymers thereof, acrylics and copolymers thereof, poly(esters), poly(styrenes) and copolymers thereof, poly(vinyl amides) and copolymers thereof, poly(vinyl alcohol) derivatives and copolymers thereof, poly(acetals) and copolymers thereof, poly(ethers) and copolymers thereof, poly(vinyl ethers) and copolymers thereof, polyvinyl (esters) and copolymers thereof, poly(imides) and copolymers thereof, poly(imines) and copolymers thereof, polycarbonates and copolymers thereof, poly(vinyl chloride) and copolymers thereof, poly(vinylidene chloride) and copolymers thereof poly(amic acids) and copolymers thereof, poly(saccharides) and derivatives thereof, and cellulose and derivatives thereof.

19. The pre-treatment composition of claim 17, wherein the second polymer is an oligomer or polymer selected from the group consisting of poly(urethanes) and copolymers thereof, acrylics and copolymers thereof, poly(esters), poly(styrenes) and copolymers thereof, poly(vinyl amides) and copolymers thereof, poly(vinyl alcohol) derivatives and copolymers thereof, poly(acetals) and copolymers thereof, poly(ethers) and copolymers thereof, poly(vinyl ethers) and copolymers thereof, polyvinyl (esters) and copolymers thereof, poly(imides) and copolymers thereof, poly(imines) and copolymers thereof, polycarbonates and copolymers thereof, poly(vinyl chloride) and copolymers thereof, poly(vinylidene chloride) and copolymers thereof poly(amic acids) and copolymers thereof, poly(saccharides) and derivatives thereof, and cellulose and derivatives thereof.

20. The pre-treatment composition of claim 14, wherein the amount of resin particles is from 1 wt. % to 45 wt. % and the water-soluble fixing agent is a multivalent metal salt.

21. The pre-treatment composition of claim 15, wherein the amount of resin particles is from 1 wt. % to 45 wt. % and the water-soluble fixing agent is a multivalent metal salt.

22. The pre-treatment composition of claim 19, wherein the amount of resin particles is from 1 wt. % to 45 wt. % and the water-soluble fixing agent is a multivalent metal salt.

23. An overcoat varnish for inkjet printing, comprising water and an aqueous dispersion comprising a surfactant according to Formula I, II, or III and a resin particle comprising a crosslinked polymeric shell, the polymeric shell comprises a polymer selected from the group consisting of poly(urea), poly(urethanes), poly(amides), poly(amines), poly(imines), poly(esters), poly(carbonates), poly(sulfonamides), and combinations thereof, 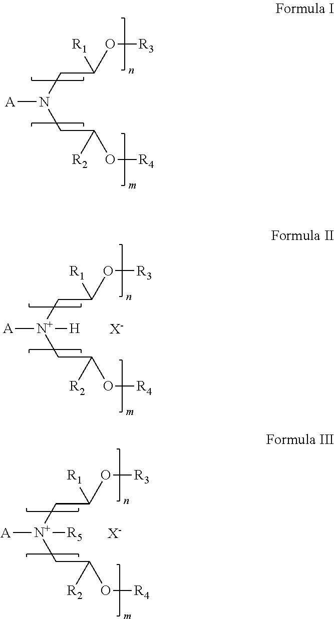
wherein
$$n + m \geq 2 ,$$
R₁ and R₂ are H, CH₃, or CH₂OH,
R₃ and R₄ are H, substituted or unsubstituted alkyl group, or a substituted or unsubstituted alkenyl group,
R₅ is a substituted or unsubstituted alkyl group, a substituted or unsubstituted alkenyl group, a substituted or unsubstituted alkynyl group, a substituted or unsubstituted aralkyl group, or a substituted or unsubstituted alkaryl group, and
A is a substituted or unsubstituted alkyl group.

24. An ink set comprising a pre-treatment composition as defined in claim 14 and an aqueous inkjet ink comprising a colorant.

25. An ink set comprising a pre-treatment composition as defined in claim 15 and an aqueous inkjet ink comprising a colorant.

26. An ink set comprising a pre-treatment composition as defined in claim 19 and an aqueous inkjet ink comprising a colorant.

27. An ink set comprising an overcoat varnish as defined in claim 23 and an aqueous inkjet ink comprising a colorant.

28. An inkjet printing method comprising the steps of:
a) applying a pre-treatment composition as defined in claim 14 onto a substrate;
b) optionally at least partially drying the applied pre-treatment composition;
c) jetting onto the applied pre-treatment composition an aqueous inkjet ink containing a colorant; and
d) applying heat to dry the jetted aqueous inkjet ink.

29. The printing method of claim 28, wherein the pre-treatment composition is applied via a jetting technique.

30. An inkjet recording method comprising the following steps:
i) jetting onto a substrate an aqueous inkjet ink containing a colorant to obtain an image; and
ii) applying an overcoat varnish as defined in claim 23 onto the obtained image of step i).

31. The recording method of claim 30, wherein the overcoat varnish is applied via a jetting technique.

32. An inkjet printing method comprising the steps of:
a) applying a pre-treatment composition as defined in claim 14 to a substrate;
b) optionally at least partially drying the applied pre-treatment composition;
c) jetting onto the applied pre-treatment composition an aqueous inkjet ink containing a colorant to obtain an image;
d) optionally at least partially drying the applied aqueous inkjet ink; and
e) applying an overcoat varnish onto at least part of the obtained image of step c)
f) applying heat to dry the applied overcoat varnish.
